(19) United States
(12) Patent Application Publication
(10) Pub. No.: US 2025/0374858 A1
(43) Pub. Date: Dec. 11, 2025

(54) PLASTIC DRAPER TRACK

(71) Applicant: MACDON INDUSTRIES LTD., Winnipeg (CA)

(72) Inventors: Eric GRENIER, Somerset (CA); Lance Thomas WILLER, Winnipeg (CA)

(21) Appl. No.: 18/875,637

(22) PCT Filed: Jun. 16, 2022
(86) PCT No.: PCT/US2022/033768

§ 371 Date: Dec. 16, 2024

(51) Int. Cl. A01D 61/00; A01D 61/02

(52) U.S. Cl. CPC A01D 61/002; A01D 61/02

(57) ABSTRACT

A draper track comprising a track portion and a lug. The track portion has a center portion and a ramp extending from an end of the center portion. The ramp is configured to guide cleats on a return run of a draper belt onto the center portion and over a header leg when the draper track is mounted on the header leg. The lug is fixedly coupled to the center portion of the track portion. The lug is configured to be coupled to the header leg.

### BACKGROUND OF THE INVENTION

### 1. Field of the Invention

The present invention relates to a draper assembly for a crop harvesting header, and more particularly, to a device for reducing wear experienced by draper cleats during operation of a draper assembly.

### 2. Description of Related Art

Draper headers for harvesting agricultural crops are known in the art. Typical draper headers include a header frame, a cutter bar operatively extending across a front portion of the header frame to cut the crops to be harvested, and a draper assembly to carry cut crop toward a discharge opening at the center of the draper header. The draper assembly includes side draper belts behind the cutter bar to carry the cut crop toward the center region of the header. The draper assembly may also include a feed draper belt that receives the cut crop material from the side drapers and carries it rearward through the discharge opening in a feeder house.

Each of the belts is typically a continuous loop of flexible material and includes cleats extending laterally along the outer surface of the belts in a direction perpendicular to the direction of belt travel. The cleats help to move the cut crop on the top run of the belts. However, because the side draper belts are made from a flexible material, they inherently sag so that the cleats tend to rub against a support frame of the header under the return run of these belts, causing the draper to wear at the cleats over time.

### SUMMARY OF THE INVENTION

According to one aspect of the invention, a draper track comprises a track portion and a lug. The track portion has a center portion and a ramp extending from an end of the center portion. The ramp is configured to guide cleats on a return run of a draper belt onto the center portion and over a header leg when the draper track is mounted on the header leg. The lug is fixedly coupled to the center portion of the track portion. The lug is configured to be coupled to the header leg.

According to another aspect of the invention, a draper header is provided for harvesting agricultural crops. The draper header comprises a header frame, a draper belt, and a draper track. The header frame extends longitudinally between opposite ends and has a header leg extending laterally between the ends of the header frame. The draper belt is rotatably supported by the header frame and extends across the header leg for transporting harvested agricultural crops. The draper belt includes a plurality of cleats extending laterally along an outer surface of the draper belt. The draper track is mounted on the header leg and comprises a track portion and a lug. The track portion has a center portion and a ramp extending from an end of the center portion. The ramp is configured to guide the cleats on a return run of the draper belt onto the center portion and over the header leg. The lug is fixedly coupled to the center portion of the track portion and is coupled to the header leg.

### BRIEF DESCRIPTION OF THE DRAWINGS

Advantages of the present disclosure will be readily appreciated as the same becomes better understood by reference to the following detailed description when considered in connection with the accompanying drawings, wherein:

FIG. 1 is a perspective view of a draper header according to a first embodiment of the present invention;

FIG. 2 is a fragmentary perspective view of the draper header of FIG. 1;

FIG. 3 is a fragmentary bottom view of the draper header of FIG. 1;

FIG. 4 is a top view of a multi-section flex header frame for the draper header of FIG. 1;

FIG. 5 is a top view of an alternate multi-section flex header frame for the draper header of FIG. 1;

FIG. 6 is a top view of a rigid one-section header frame for the draper header of FIG. 1;

FIG. 7 is a front perspective view of a draper track according to the first embodiment of the present invention;

FIG. 8 is a front view of the draper track of FIG. 7;

FIG. 9 is a bottom view of the draper track of FIG. 7;

FIG. 10 is a top view of the draper track of FIG. 7;

FIG. 11 is a cross-sectional view of the draper track taken along line 11-11 of FIG. 9;

FIG. 12 is another cross-sectional view of the draper track taken along line 12-12 of FIG. 9;

FIG. 13 is a rear perspective view of the draper track of FIG. 7;

FIG. 14 is an enlarged fragmentary front perspective view of the draper track of FIG. 7 mounted on a header leg;

FIG. 15 is an enlarged fragmentary rear perspective view of the draper track and header leg of FIG. 14;

FIG. 16 is an enlarged fragmentary front perspective view of the draper track and header leg of FIG. 14;

FIG. 17 is a perspective view of a draper track according to a second embodiment of the present invention;

FIG. 18 is a front view of a draper track according to a third embodiment of the present invention;

FIG. 19 is a bottom view of a draper track according to a fourth embodiment of the present invention; and

FIG. 20 is a top view of the draper track of FIG. 19.

### DETAILED DESCRIPTION OF THE EMBODIMENTS

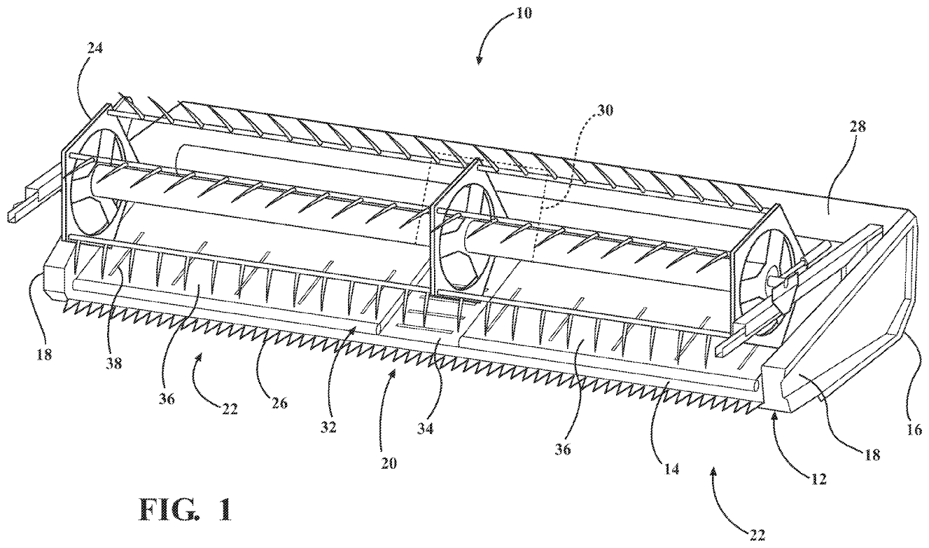

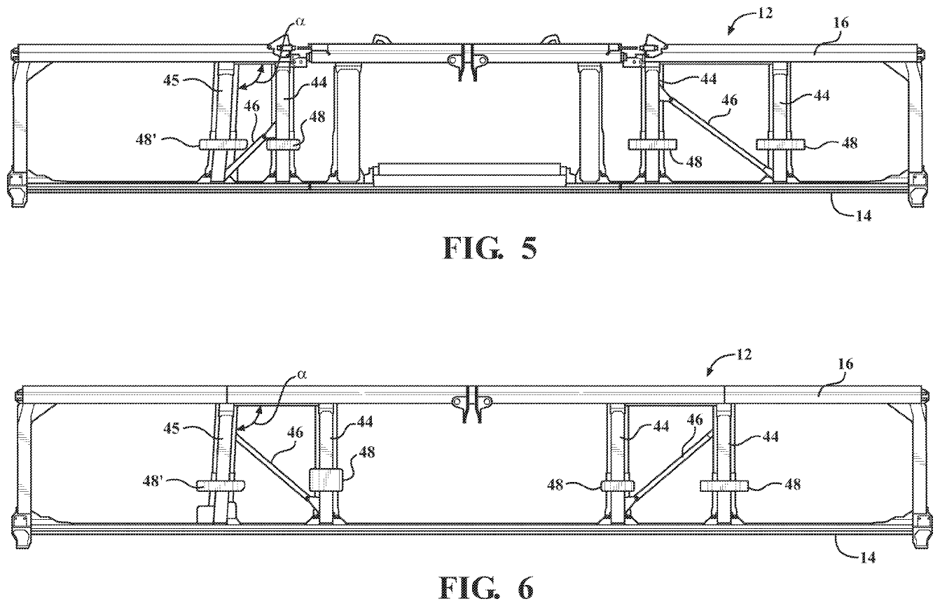

Referring to the Figures, wherein like numerals indicate like or corresponding parts throughout the several views, a draper header for harvesting agricultural crops is shown generally at 10. The header 10 includes a header frame 12 with a front portion 14 and a rear portion 16 extending longitudinally between opposite ends 18. Referring to FIGS. 1-5, the header frame 12 is divided into a middle frame section 20 pivotally coupled between a pair of side wing sections 22. The side wing sections 22 are pivotable upwardly and downwardly relative to the middle frame section 20 to contour to the field as the draper header 10 moves across the field harvesting crops. Alternatively, the middle frame section 20 may be rigidly coupled between the side wing sections 22 as shown in FIG. 6.

Referring to FIG. 1, crop pick-up reels 24 are positioned generally above the front portion 14 of the header frame 12 for engaging the crops to be harvested. A cutter bar assembly 26 operatively extends across the front portion 14 of the header frame 12 between the opposite ends 18 for cutting the crops to be harvested. A rear wall 28 extends substantially vertically along the rear portion 16 of the header frame 12 between the opposite ends 18 thereof. The rear wall 28 includes an opening 30 for transferring crops away from the header 10 for further processing by an agricultural machine such as a combine or for creation of windrows by a swather. However, it is to be appreciated that the crops may be transferred from the draper header 10 for any number of other suitable purposes without varying the scope of the invention.

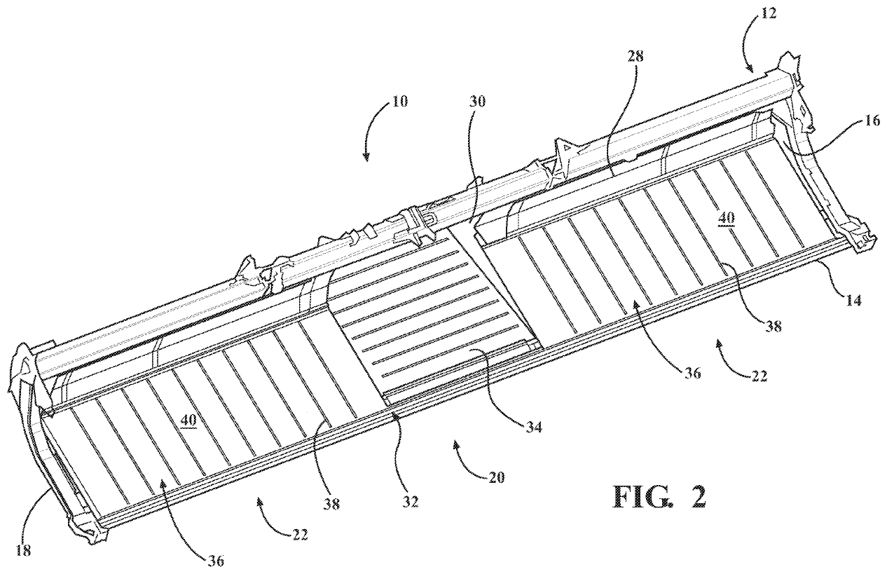

Referring to FIGS. 1-2, the header 10 further includes a draper belt assembly 32 supported by the header frame 12. The draper belt assembly 32 extends behind the cutter bar assembly 26 and includes a pair of side draper belts 36 on the side wing sections 22. When attached to a combine rather than a swather, the side draper belts 36 transport harvested agricultural crops to a feed draper belt 34 on the middle frame section 20, which then directs the harvested crops through the opening 30 in the rear wall 28.

Each side draper belt 36 is tensioned between a pair of laterally spaced-apart rollers rotatably coupled between the front and rear portions 14, 16 of the header frame 12. Referring to FIGS. 1-3, each of the side draper belts 36 includes a plurality of cleats 38 extending laterally along an outer surface of the belt 36 in a direction perpendicular to the direction of belt travel. The cleats 38 aid in transporting the harvested crops. Each side draper belt 36 includes a top run 40 spaced above and parallel to an opposite return run 42.

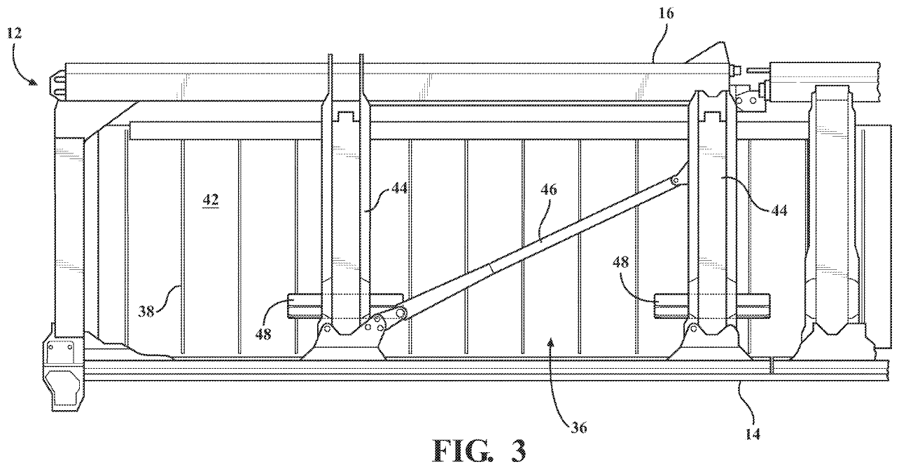

Referring to FIGS. 3-6, the header frame 12 includes a plurality of header legs 44 extending between the front portion 14 and the rear portion 16 of the header 10 under the draper belt assembly 32. One of the header legs 44 is a cross leg 45 that extends at an angle α between the front portion 14 and the rear portion 16 of the header 10 under the draper belt assembly 32. A brace member 46 extends from the front portion 14 of one header leg 44, 45 toward a rear portion 16 of an adjacent header leg 44, 45. One or more draper tracks 48 are mounted onto each header leg 44.

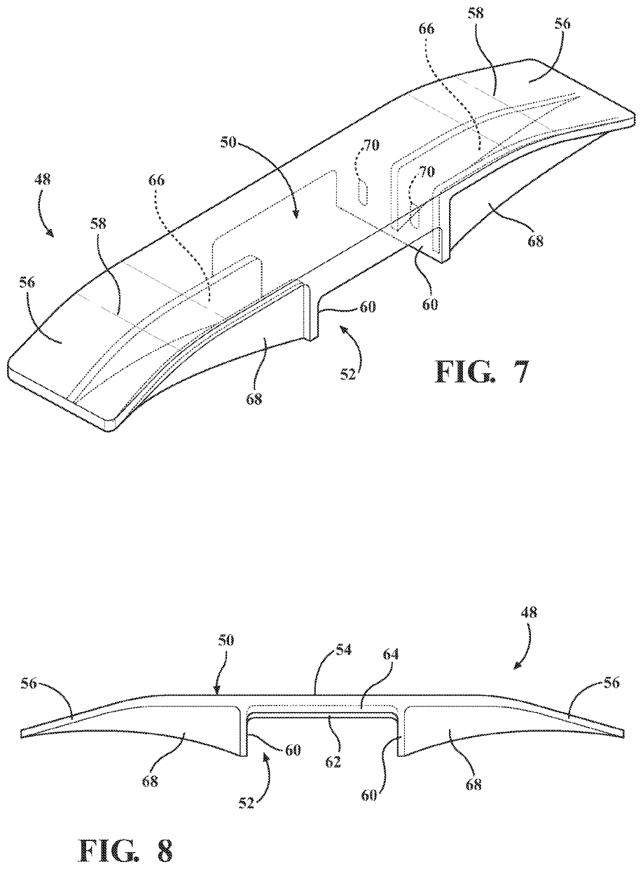

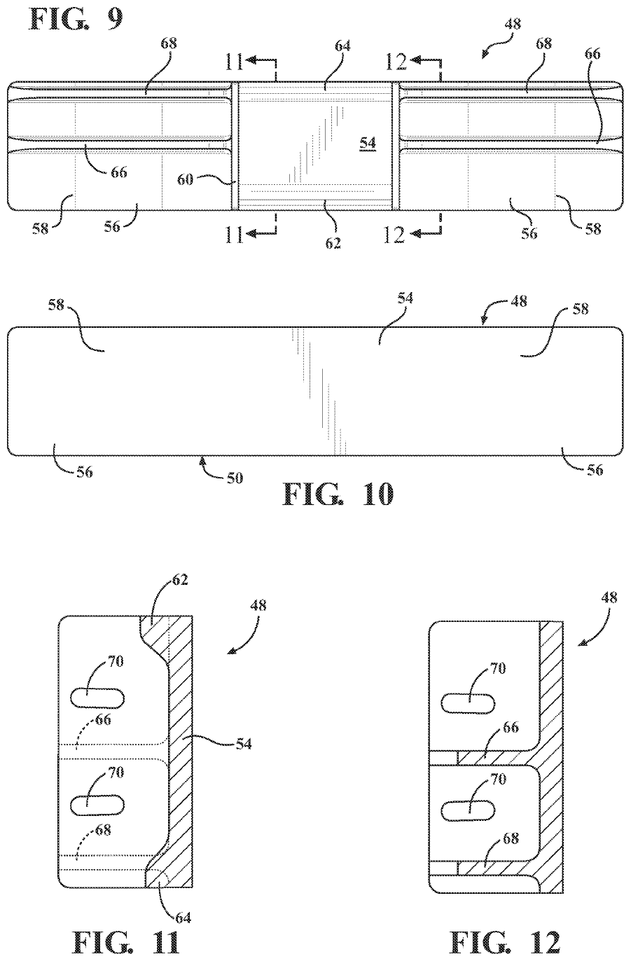

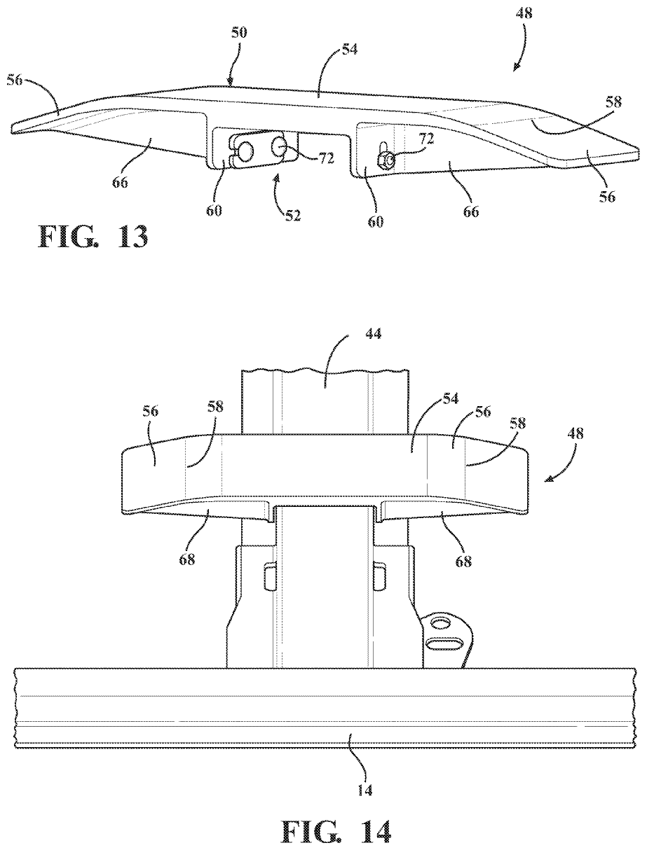

Referring to FIGS. 7-13, each draper track 48 includes a track portion 50 and a lug 52 connected to the bottom of the track portion 50. The length and the width of the track portion 50 may vary without departing from the scope of the invention. The track portion 50 comprises a longitudinal strip defined by a center portion 54 extending longitudinally between a pair of downwardly angled ramps 56 extending from each end of the center portion 54. Each ramp 56 includes a bend 58 extending transversely across the ramp 56. Alternatively, the ramp 56 may include a plurality of bends 58 extending transversely across the ramp 56, or it may omit the bend 58 entirely.

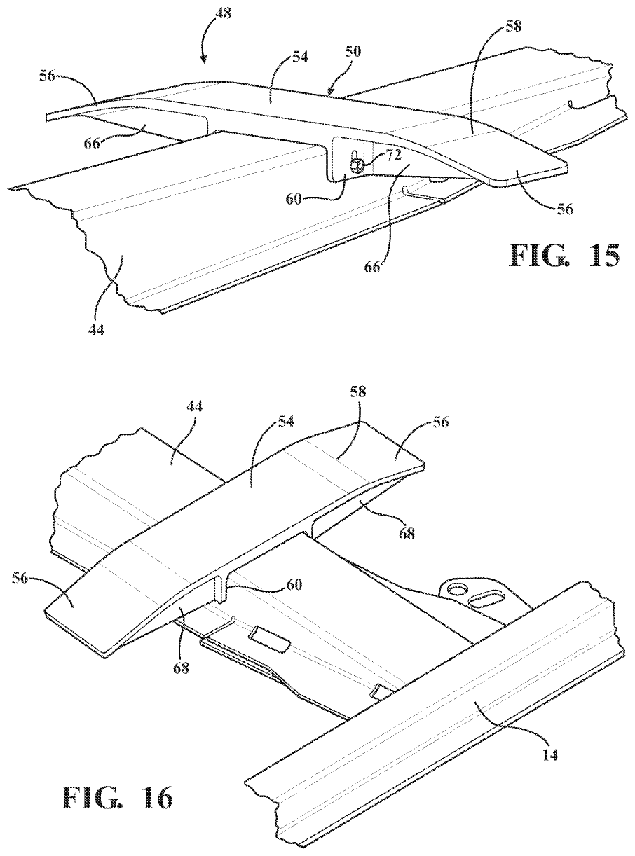

The lug 52 is longitudinally centered on the center portion 54 of the track portion 50 and includes a pair of transverse walls 60 extending from the bottom of the track portion 50. The transverse walls 60 extend at 90 degree angles relative to the track portion 50. The lug 52 may also be offset from the center of the center portion 54 without varying the scope of the invention. Each wall 60 includes a pair of apertures 70. Referring to FIGS. 14-16, the walls 60 of the lug 52 extend along sides of the header leg 44, and fasteners 72 extend through the apertures 70 to secure the draper track 48 onto the sides of the header leg 44.

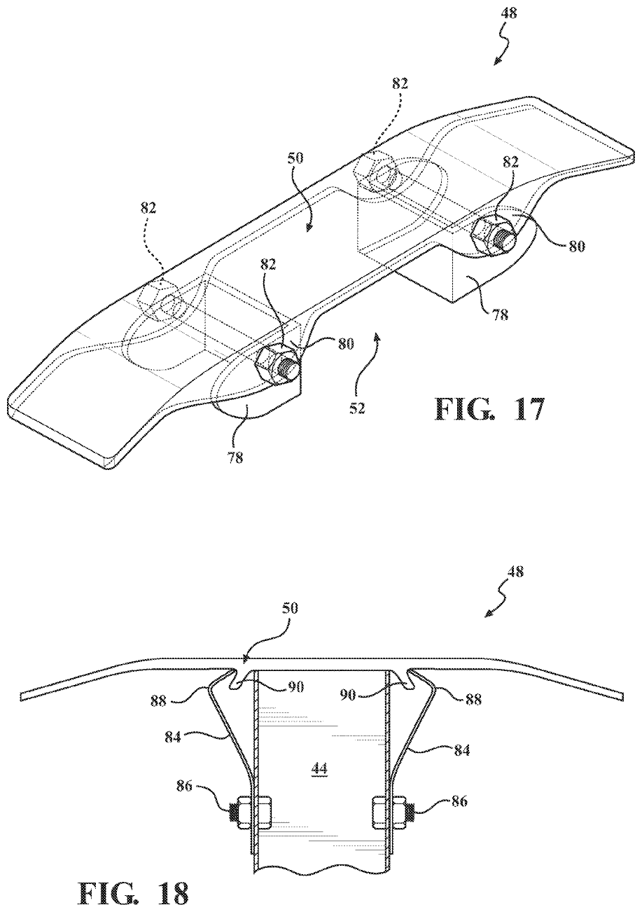

The track portion 50 may be integrally molded or extruded from plastic, such as Ultra High Molecular Weight Polyethylene (UHMW-PE), having a lower coefficient of friction than the header legs 44, 45 and cleats 38 to thereby reduce the wear on the cleats 38 and draper belts 36. The lug 52 may be integrally molded to the bottom of the track portion 50. Alternatively, as reflected in FIGS. 17-18, the lug 52 could be a separate piece attached to the bottom of the track portion 50. For example, referring to FIG. 17, the lug 52 could include a pair of brackets 78 attached to sides 80 extending downwardly from the track portion 50. The lugs 78 may be attached using nuts and bolts 82 or any suitable fasteners. Referring to FIG. 18, the lug 52 may alternatively include a pair of clamp plates 84 configured to be mounted to the header leg 44 using bolts 86 or other suitable fasteners. The top portion 88 of the clamp plates 84 bend inwardly toward the center to frictionally engage with a pair of transverse tabs 90 extending outwardly from the bottom of the track portion 50.

Referring to FIGS. 8, 9 and 11, the draper track 48 also includes a pair of ribs 62, 64 extending from the bottom of the track portion 50 between the walls 60 of the lug 52 along the sides of the center portion 54. Because the header leg 44 and side draper belt 36 are not parallel to one another, the rib 62 closer to the rear portion 16 of the header 10 is taller than the rib 64 closer to the front portion 14 of the header 10 thereby angling the draper track 48 relative to the header leg 44 so that the center portion 54 is parallel to the side draper belt 36 when the draper track 48 is mounted on the header leg 44.

Referring to FIGS. 7-9 and 11-16, the draper track 48 further includes center supports 66 and off-center supports 68 extending longitudinally from each of the walls 60 of the lug 52 toward the ends of the track portion 50. The center supports 66 and off-center supports 68 are fixedly connected to the wall 60 and the bottom of the track portion 50 and taper longitudinally from the wall 60 to the distal ends of the track portion 50. The center support 66 extends substantially along the longitudinal center of the track portion 50. Although depicted on one side of the draper track 48, the off-center supports 68 may be placed on one or both sides of the draper track 48.

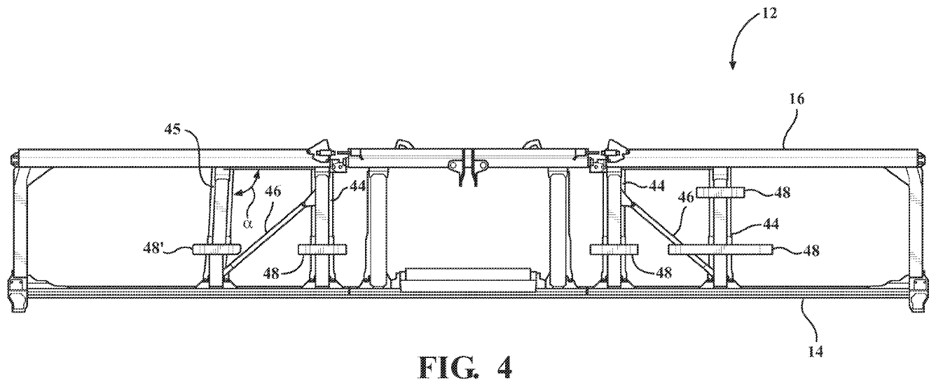

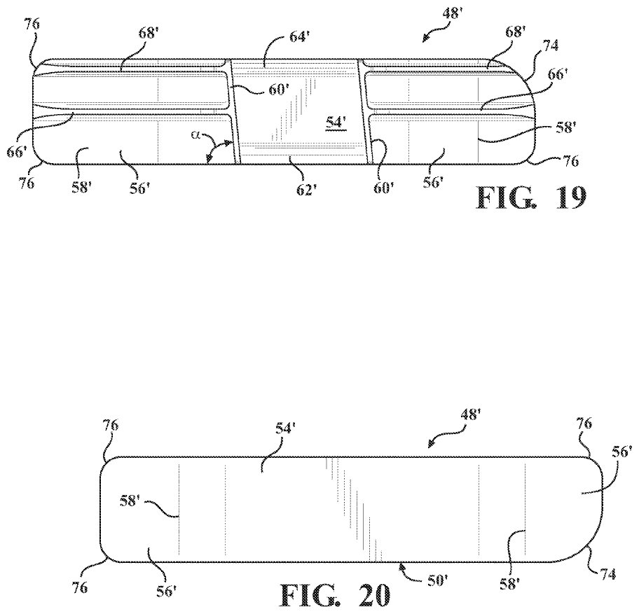

FIGS. 4-6 and 19-20 illustrate another embodiment of a draper track 48′, wherein like primed reference numerals represent similar elements as those described above. The draper track 48′ is mounted on the cross leg 45 of the header frame 12. Because the cross leg 45 extends at an angle α between the front portion 14 and the rear portion 16 of the header 10, the transverse walls 60′ of the lug 52′ also extend at the angle α relative to the track portion 50′ so that when mounted on the cross leg 45, the track portion 50′ is parallel to the direction that the side draper belt 36 travels. One corner 74 of the track portion 50′ is shorter than the other corners 76.

In operation, one of the ramps 56, 56′ on the draper tracks 48, 48′ guides the cleats 38 on the return run 42 of the side draper belt 36 onto the center portion 54, 54′ of the draper track 48, 48′ and over the header leg 44, 45. The other ramp 56, 56′ on the draper track 48, 48′ guides the cleats 38 off the header leg 44, 45. By guiding the cleats 38 over the header leg 44, 45, the draper tracks 48, 48′ prevent the cleats 38 from rubbing against the header legs 44, 45, thereby reducing friction and wear on the side draper belts 36.

The invention has been described in an illustrative manner, and it is to be understood that the terminology which has been used is intended to be in the nature of words of description rather than of limitation. Directional references employed or shown in the description, figures or claims, such as top, bottom, upper, lower, upward, downward, lengthwise, widthwise, longitudinal, lateral, and the like, are relative terms employed for ease of description and are not intended to limit the scope of the invention in any respect. Many modifications and variations of the present invention are possible in light of the above teachings. It is, therefore, to be understood that within the scope of the appended claims, the invention may be practiced other than as specifically described.

What is claimed is:

1. A draper track comprising:
a track portion having a center portion and a ramp extending from an end of the center portion, wherein the ramp is configured to guide cleats on a return run of a draper belt onto the center portion and over a header leg when the draper track is mounted on the header leg; and
a lug fixedly coupled to the center portion of the track portion, wherein the lug is configured to be coupled to the header leg.

2. The draper track of claim 1 further comprising a second ramp extending from a second end of the center portion, wherein the second ramp is configured to guide the cleats off the header leg when the draper track is mounted on the header leg.

3. The draper track of claim 1 further comprising a support extending from the lug along a bottom of the track portion.

4. The draper track of claim 3 wherein the support extends along a center of the track portion.

5. The draper track of claim 4 further comprising a second support extending from the lug along a bottom of the track portion wherein the second support is configured to extend adjacent a side of the track portion.

6. The draper track of claim 1 wherein the ramp includes a bend extending transversely across the ramp.

7. The draper track of claim 1 wherein the lug is integrally molded with the track portion.

8. The draper track of claim 1 wherein the lug comprises a pair of transverse walls extending at an angle from the bottom of the track portion.

9. The draper track of claim 8, wherein the angle comprises 90 degrees.

10. The draper track of claim 8 further comprising a pair of ribs extending from the bottom of the track portion between the walls of the lug, wherein the ribs extend along sides of the center portion.

11. The draper track of claim 10 wherein the ribs are configured to angle the draper track so that the center portion is parallel to the draper belt when the draper track is installed on the header leg.

12. The draper track of claim 1 comprising a molded piece of plastic.

13. The draper track of claim 1, further comprising a fastener to fixedly couple the lug to the track portion.

14. The draper track of claim 1, wherein the lug comprises a pair of clamp plates configured to frictionally engage with a pair of transverse tabs extending from the track portion.

15. A draper header for harvesting agricultural crops, the draper header comprising:
a header frame extending longitudinally between opposite ends and having a header leg extending laterally between the ends of the header frame;
a draper belt rotatably supported by the header frame and extending across the header leg for transporting harvested agricultural crops, wherein the draper belt includes a plurality of cleats extending laterally along an outer surface of the draper belt; and
a draper track mounted on the header leg, wherein the draper track comprises:
a track portion having a center portion and a ramp extending from an end of the center portion, wherein the ramp is configured to guide the plurality of cleats on a return run of the draper belt onto the center portion and over the header leg; and
a lug fixedly coupled to the center portion of the track portion, wherein the lug is coupled to the header leg.

16. The draper header of claim 15 wherein the draper track further comprises a second ramp extending from a second end of the center portion, wherein the second ramp is configured to guide the cleats off the header leg.

17. The draper header of claim 15 wherein the draper track further comprises a support extending from the lug along a bottom of the track portion.

18. The draper header of claim 17 wherein the support extends along a center of the track portion.

19. The draper header of claim 18 wherein the draper track further comprises a second support extending from the lug along a bottom of the track portion wherein the second support is configured to extend adjacent a side of the track portion.

20. The draper header of claim 15 wherein the ramp includes a bend extending transversely across the ramp.

21. The draper header of claim 15 wherein the lug is integrally molded with the track portion.

22. The draper header of claim 15 wherein the lug comprises a pair of transverse walls extending at an angle from the bottom of the track portion.

23. The draper header of claim 22, wherein the angle comprises 90 degrees.

24. The draper header of claim 22 wherein the draper track further comprises a pair of ribs extending from the bottom of the track portion between the walls of the lug, wherein the ribs extend along sides of the center portion.

25. The draper header of claim 24 wherein the ribs are configured to angle the draper track so that the center portion is parallel to the draper belt.

26. The draper header of claim 15, wherein the draper track comprises a molded piece of plastic.

27. The draper header of claim 15 wherein the draper track further comprises a fastener to fixedly couple the lug to the track portion.

28. The draper header of claim 15 wherein the lug comprises a pair of clamp plates configured to frictionally engage with a pair of transverse tabs extending from the track portion.

29. The draper header of claim 15 further comprising:
a second draper track mounted on the header leg, wherein the second draper track comprises:
a second track portion having a second center portion and a second ramp extending from an end of the second center portion, wherein the second ramp is configured to guide the plurality of cleats on a return run of the draper belt onto the second center portion and over the header leg; and
a second lug fixedly coupled to the second center portion of the second track portion, wherein the second lug is coupled to the header leg.
